(19) United States
(12) Patent Application Publication
(10) Pub. No.: US 2008/0017794 A1
(43) Pub. Date: Jan. 24, 2008

(54) COAXIAL RING ION TRAP

(75) Inventor: Guido Fridolin Verbeck, Plano, TX (US)

Correspondence Address: HAYNES AND BOONE, LLP, 901 Main Street, Suite 3100, Dallas, TX, 75202, US

(73) Assignee: Zyvex Corporation, Richardson, TX (US)

(21) Appl. No.: 11/458,254

(22) Filed: Jul. 18, 2006

(51) Int. Cl. H01J 49/42

(52) U.S. Cl. 250/292

(57) ABSTRACT

An apparatus that is or includes an ion trap, wherein the ion trap comprises an injection endcap, an extraction endcap, a plurality of ring electrode segments collectively positioned in substantially coaxial alignment between the injection and extraction endcaps, and a plurality of insulators each interposing neighboring ones of the plurality of ring electrode segments.

### BACKGROUND

A mass spectrometer is a device that filters gaseous ions according to their mass-to-charge (m/z) ratio and measures the relative abundance of each ionic species. A typical mass spectrometer comprises an ionization source to generate ions, a mass filter to separate ions in space and/or time, an ion detector to collect filtered ions and measure their relative abundance, a gas supply/vacuum system, and means to power the spectrometer.

Mass spectrometer performance is generally given in terms of mass range, resolution or resolving power, and sensitivity of the instrument. The mass range regards the lowest and highest masses that can be measured with a particular instrument. For example, a large mass range is desired for the analysis of high molecular weight organic and biological analytes. Resolution (definition of resolution is actual peak shape), or resolving power, regards the ability of the instrument to separate and identify ions of slightly different masses. Sensitivity regards the instrument's response to ions of an arbitrary m/z ratio for a particular sample.

Recently, there has been a growing interest in the miniaturization of mass spectrometers. The effect of miniaturization on instrument performance depends on the method of mass analysis. For many methods, mass range and resolution often decrease with miniaturization. However, sensitivity may be improved, while power and pumping requirements may be reduced compared to conventional instruments. In general, the smaller dimensions of miniature analyzers reduces the number of collisions that the ion makes with background gases due to the reduced distance of travel. Therefore, operating pressure requirements may be relaxed with miniaturization.

Mass spectrometers can be classified according to the method by which mass filtering is accomplished using electric and/or magnetic fields. For example, mass filter types can include linear quadrupole, quadrupole ion traps, and cylindrical ion traps, among others.

Linear quadrupole mass spectrometers (QMS) filter ions by passing them through tuned radio-frequency (rf) and direct current (dc) electrical fields defined by four, symmetrically parallel quadrupole rods. The QMS permits only those ions with a stable trajectory, determined by their m/z ratio, to travel along the entire length of the central axis of the rod assembly without being deflected out of the intra-rod space. Ions with different m/z ratios can be scanned through the QMS by continuously varying the field between the quadrupole rods. Miniature linear quadrupoles require lower drive voltages and higher rf drive frequencies to filter heavier ions and maintain resolution as the electrode dimensions decrease. The relative dimensional and positional precision of the parts must be maintained to provide adequate filtering as their size is reduced.

A three-dimensional analogue of the linear QMS is the quadrupole ion trap (QIT). Like the linear quadrupole, the QIT can control the stability of ion motion in an electric field and can therefore be used for mass analysis. The QIT comprises a central, donut-shaped hyberboloid ring electrode and two hyperbolic endcap electrodes. In normal usage, the endcaps are held at a static potential, and the rf oscillating drive voltage plus DC offset is applied to the ring electrode. Ion trapping occurs due to the formation of a trapping potential well in the central intraelectrode region when appropriate time-dependent voltages are applied to the electrodes. The ions orbit in the trap are stabilized or destabilized as the trapping conditions are changed. With mass-selective ejection of ions, the ions become unstable in the Z-direction of the well and are ejected from the trap in order of ascending m/z ratio as the rf voltage or frequency applied to the ring is ramped. The ejected ions can be detected by an external detector, such as an electron multiplier, after passing through an aperture in one of the endcap electrodes. Like the QMS, ion traps have the advantage of being able to operate at higher pressures as a function of smaller size.

Unlike most other methods of mass analysis, a decrease in the dimensions of the QIT allows trapping of higher m/z ratio ions for fixed operating parameters. Alternatively, for a given m/z ratio, the voltage required to eject ions is reduced quadratically with the linear trap dimension, enabling lower voltages to be used to analyze the same mass range. Like the linear quadrupole, the drive frequency of the QIT must be increased to maintain resolution as the spectrometer dimensions are decreased. A major problem with the miniature ion trap is that the ion storage capacity of the trap decreases with size, reducing the dynamic range and sensitivity.

A cylindrical ion trap (CIT), comprises planar endcap electrodes and a cylindrical ring electrode instead of hyperbolic electrode surfaces, and produces a field that is approximately quadrupolar near the center of the trap. Therefore, CITs have been found to provide performance comparable to QlTs. Moreover, the CIT is favored for miniature ion storage and mass analysis devices because CITs are mechanically simple and can be easily machined. Arrays of miniature CITs, with trap dimensions on the order of a millimeter, have been manufactured using precision machining to regain a portion of the lost storage capacity and thereby improving sensitivity.

The inner radius of the trapping ring electrode determines the m/z ratio of the trapped ions. Therefore, variable parallel arrays of miniature CITs, each individual trap having a proportionately different size, can be configured to simultaneously trap and monitor different-sized ions. A low-resolution spectra of a multiple ion sample can be obtained from such a variable parallel array by simultaneously ejecting the trapped ions with a dc pulse, without the need to scan the applied rf voltage. The ejected ions can be detected with a position-sensitive detector, resulting in a reduced power requirement and simplification of the ion trap control electronics.

Alternatively, the use of multiple traps in a single parallel array can offset some of the loss in ion storage capacity with miniaturization. In the standard mass-ejection analysis mode, parallel arrays of miniature CITs having the same trap dimensions can be scanned to provide simultaneous ejection of similar ions from all traps, providing improved sensitivity.

Serial arrays of such miniature CITs can be also be used for ion storage, mass selection, and ion reaction and product ion analysis. For example, serial arrays of miniature CITs, wherein ions trapped in a first CIT are transferred to a second CIT, can be used to provide multiple stages of mass isolation and analysis in a tandem or multistage capability.

However, precision machining methods only provide arrays of miniature CITs comprising a few millimeter-sized traps. Furthermore, bulk micromachining techniques, whereby holes are etched in a semiconductor body or wafer, provide traps with trap dimensions comparable to the wafer thickness (e.g., hundreds of microns). These relatively large traps are not well suited for truly field portable, handheld microanalytical systems. Such microanalytical systems, or “chemical laboratories on a chip,” are being developed to enable the rapid and sensitive detection of particular chemicals, including pollutants, high explosives, and chemical warfare agents. These microanalytical systems should provide a high degree of chemical selectivity to discriminate against potential background interferents, be able to perform the chemical analysis on a short time scale, and consume low amounts of electrical power for prolonged field use.

Moreover, ion resolution and attenuation have become an issue with ion traps as they are miniaturized. Current cylindrical ion traps, due to their size constraints for optimal resolution (e.g., length approximately equal diameter), experience limited ion storage because of space charge effects.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a sectional view of at least a portion of apparatus according to one or more aspects of the present application.

FIG. 2A is a top view of at least a portion of apparatus during an intermediate stage of manufacture according to one or more aspects of the present application.

FIG. 2B is a top view of the apparatus shown in FIG. 2A in a subsequent stage of manufacture according to one or more aspects of the present application.

FIG. 2C is a top view of the apparatus shown in FIG. 2B in a subsequent stage of manufacture according to one or more aspects of the present application.

FIG. 2D is a top view of the apparatus shown in FIG. 2C in a subsequent stage of manufacture according to one or more aspects of the present application.

FIG. 3 is a schematic view of at least a portion of a system according to one or more aspects of the present application.

FIG. 4 is a chart demonstrating the time/mass relationship for apparatus of the prior art and for apparatus according to one or more aspects of the present application.

FIG. 5 is a schematic view of at least a portion of apparatus according to one or more aspects of the present application.

FIG. 6 is a chart graphically depicting an operational example according to one or more aspects of the present application.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

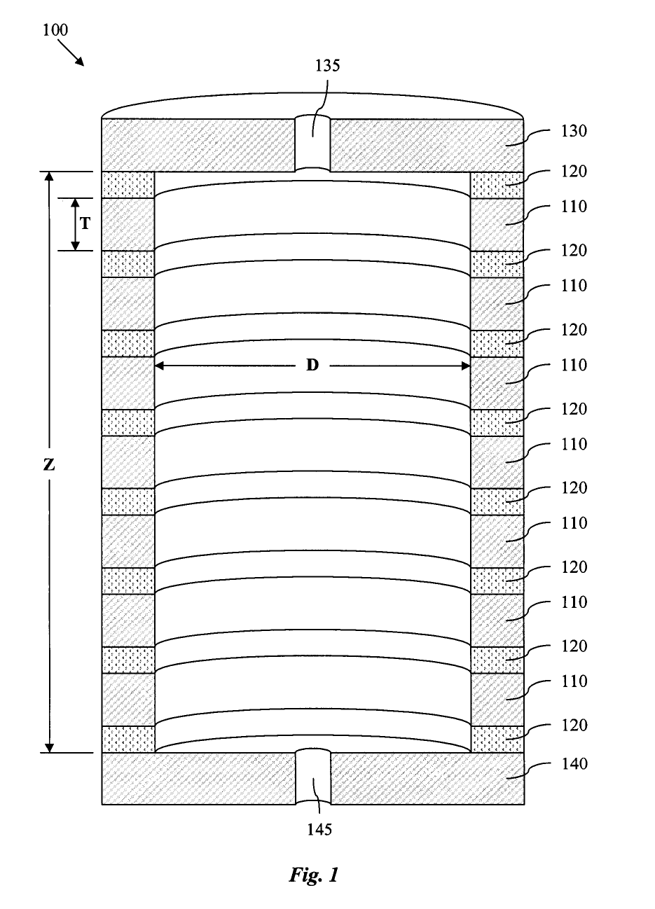

Referring to FIG. 1, illustrated is a sectional view of at least a portion of apparatus 100 according to one or more aspects of the present application. The apparatus 100 may be, or be included in, a coaxial ring ion trap.

The apparatus 100 includes a plurality of ring electrode segments 110 each having a substantially cylindrical annulus shape. Each segment 110 may have an internal diameter D ranging between about 100 μm and about 1 cm. For example, each segment 110 may have an internal diameter D of about 1 mm. Each segment 110 may also have a thickness T ranging between about 1 μm and about 100 μm, such as a thickness T of about 50 μm. The internal diameter D of each of the segments 110, and/or the thickness T of each of the segments 110, is not necessarily the same. For example, the diameter D of centrally located ones of the segments 110 may be slightly or substantially larger than the diameter D of opposing ones of the segments 110.

The apparatus 100 may also include a plurality of insulators 120 each interposing neighboring ones of the ring segments 110. Each insulator 120 may have an internal diameter substantially equal to the diameter D of neighboring ones of the segments 110, and may be coaxially aligned with neighboring ones of the segments 110. The insulators 120 may each be formed directly on a neighboring one of the segments 110, such as on an immediately previously formed segment 110. However, the apparatus 100 may also include additional layers interposing neighboring ones of the segments 110 and insulators 120. For example, such additional layers may comprise one or more adhesive layers, etch stop layers, and/or implant barrier layers, among others.

The apparatus 100 may also include one or more endcaps. For example, in the embodiment depicted in FIG. 1, the apparatus 100 includes an injection endcap 130 and an extraction endcap 140. The endcap 130 includes an aperture 135 through which ions are injected into the apparatus 100, and the endcap 140 includes an aperture 145 through which ions are extracted or expelled from the apparatus 100. The apertures 135, 145 may each have a diameter ranging between about 10 μm and about 2.5 mm. For example, the apertures 135, 145 may each have a diameter of about 250 μm. However, other diameters of the apertures 135, 145 are also within the scope of the present application.

The endcaps 130, 140 may comprise doped silicon, stainless steel, aluminum, copper, nickel plated silicon or other nickel plated materials, gold, and/or other electrically conductive materials, and may be formed by laser etching, Liga, reactive ion etching (RIE) and other types of etching, micromachining, and/or other manufacturing processes. Also, the endcaps 130, 140 may be substantially similar in composition and/or manufacture relative to one or more of the segments 110.

The ring segments 110 and insulators 120, and perhaps the endcaps 130, 140 when employed, collectively define an internal volume of the apparatus 100. The volume is substantially cylindrical, having a diameter D and a height Z. The height Z may range between about 100 μm and about 1 cm. For example, the height Z may be about 1.05 mm. However, the height Z is not limited within the scope of the present application, and may vary depending on the number and/or thickness of the ring segments 110 and/or insulators 120.

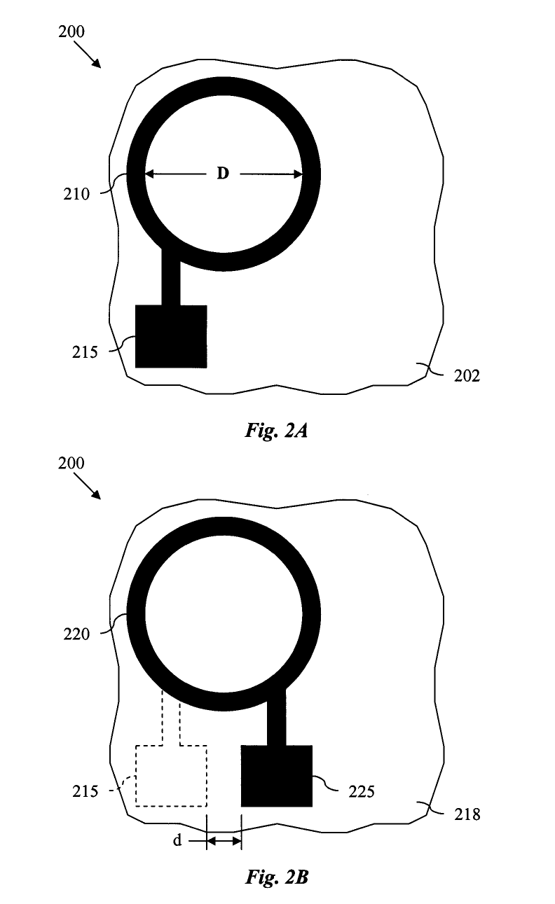

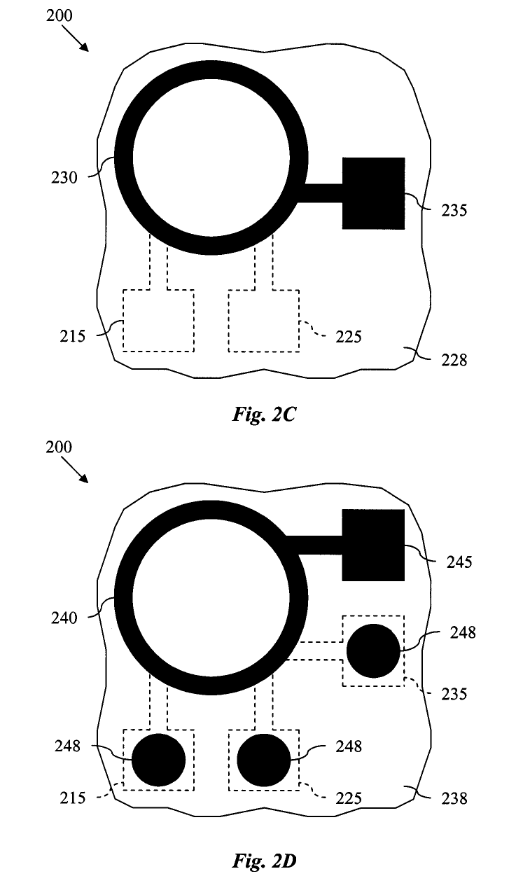

Referring to FIG. 2A, illustrated is a top view of at least a portion of an apparatus 200 in an intermediate stage of manufacture according to one or more aspects of the present application. One or more aspects of the apparatus 200 may be substantially similar to one or more aspects of the apparatus 100 depicted in FIG. 1.

The apparatus 200 includes a ring segment 210 formed on or over a substrate 202. The ring segment 210 may be substantially circular, or cylindrical, and may include one or more layers comprising doped silicon, stainless steel, aluminum, copper, nickel plated silicon or other nickel plated materials, gold, and/or other electrically conductive materials. The ring segment 210 may include one or more layers formed on or over the substrate 202 by laser etching, Liga, reactive ion etching (RIE) and other types of etching, micromachining, and/or other manufacturing processes. An internal diameter D of the ring segment 210 may be substantially similar to the diameter D depicted in FIG. 1 and described above. An external diameter of the ring segment 210 may be about 20% greater than the internal diameter D, although other ratios of the internal and external diameters are also within the scope of the present application.

While the ring segment 210 is being formed, a contact 215 may also be formed substantially planar to the ring segment 210. Thus, for example, the contact 215 may be substantially similar in composition and/or manufacture relative to the ring segment 210. Accordingly, the contact 215 may be integrally formed with the ring segment 210. However, other configurations for forming and electrically connecting the contact 215 and ring segment 210 are also within the scope of the present application.

Referring to FIG. 2B, illustrated is a top view of the apparatus 200 shown in FIG. 2A in a subsequent stage of manufacture according to one or more aspects of the present disclosure. An insulator 218 may be formed on or over the ring segment 210 and contact 215 before subsequently forming an additional ring segment 220 and contact 225 on or over the insulator 218. The ring segment 220 may be substantially similar to the ring segment 210, and may be substantially coaxially aligned with the ring segment 210. The contact 225 may be substantially similar to the contact 215, although the contact 225 may be laterally offset from the contact 215 with respect to the substrate 202 and/or insulator 218, such as by an offset distance d. The offset distance d may range between about 10 μm and about 2.5 mm, although other values are also within the scope of the present application.

The insulator 218 may include one or more layers comprising air, polyamide, polymer, Teflon, and/or other dielectric or non-conductive materials. The insulator 218 may be substantially similar in composition and/or manufacture to the insulators 120 shown in the embodiment depicted in FIG. 1.

Referring to FIG. 2C, illustrated is a top view of the apparatus 200 shown in FIG. 2B in a subsequent stage of manufacture according to one or more aspects of the present disclosure. An insulator 228 may be formed on or over the ring segment 220 and contact 225. The insulator 228 may be substantially similar in composition and/or manufacture to the insulator 218 shown in FIG. 2B.

An additional ring segment 230 and contact 235 may then be formed on or over the insulator 228. The ring segment 230 may be substantially similar to the ring segments 210, 220, and may be substantially coaxially aligned with the ring segments 210, 220. The contact 235 may be substantially similar to the contacts 215, 225, although the contact 235 may be laterally offset from the contacts 215, 225 with respect to the substrate 202 and/or insulator 228.

Referring to FIG. 2D, illustrated is a top view of the apparatus 200 shown in FIG. 2C in a subsequent stage of manufacture according to one or more aspects of the present disclosure. An insulator 238 may be formed on or over the ring segment 230 and contact 235. The insulator 238 may be substantially similar in composition and/or manufacture relative to the insulators 218, 228 shown in FIGS. 2B, 2C, respectively.

An additional ring segment 240 and contact 245 may then be formed on or over the insulator 238. The ring segment 240 may be substantially similar to the ring segments 210, 220, 230, and may be substantially coaxially aligned with the ring segments 210, 220, 230. The contact 245 may be substantially similar to the contacts 215, 225, 235, although the contact 245 may be laterally offset from the contacts 215, 225, 235 with respect to the substrate 202 and/or insulator 238.

As also depicted in FIG. 2D, the apparatus 200 may include contacts 248 each extending through one or more of the insulators 218, 228, 238 to corresponding ones of the contacts 215, 225, 235. The contacts 248, in conjunction with the contact 245 or a contact extending therefrom, may be utilized to electrically bias individual ones of the ring segments 210, 220, 230, 240. The insulators 218, 228, 238 may be configured to electrically isolate each of the ring segments 210, 220, 230, 240 from each other, such that any one of the ring segments can be electrically biased individually without also inadvertently biasing any of the other ring segments.

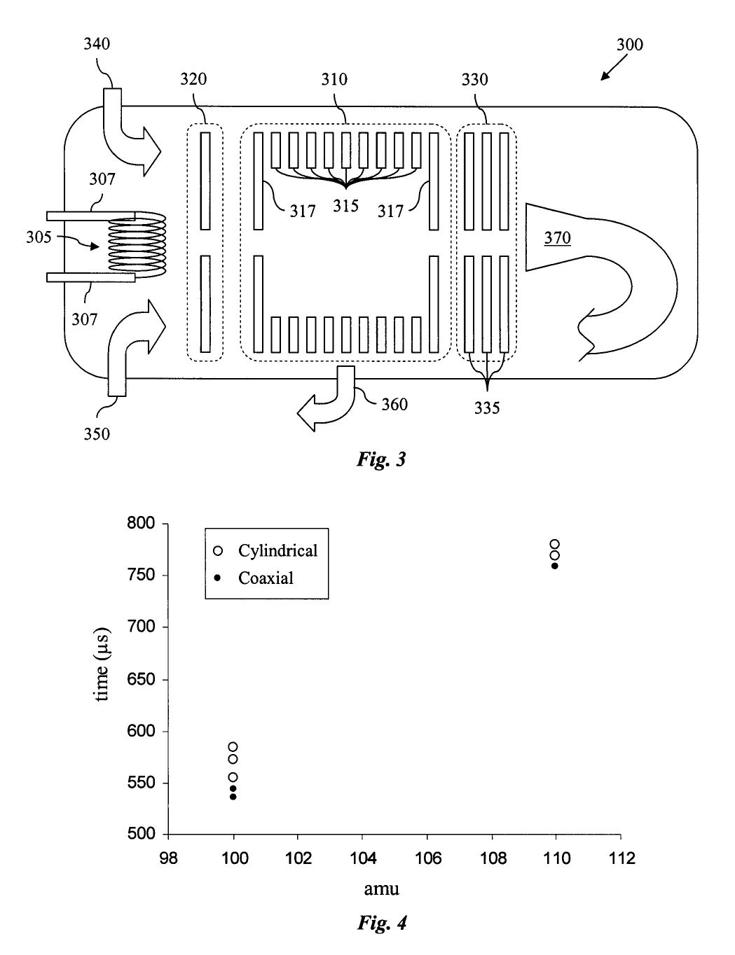

Referring to FIG. 3, illustrated is a schematic view of at least a portion of an apparatus 300 according to one or more aspects of the present disclosure. The apparatus 300 represents one environment in which the apparatus 100 and/or 200 described above may be implemented. For example, the apparatus 300 includes a coaxial ring ion trap 310 that may be substantially similar in composition and/or manufacture to the apparatus 100 shown in FIG. 1 and/or the apparatus 200 shown in FIG. 2D, or may otherwise have one or more aspects in common with the apparatus 100 of FIG. 1 and/or the apparatus 200 of FIG. 2D.

Thus, for example, the ion trap 310 includes a plurality of independently biasable and coaxially aligned ring segments 315. One or more insulators interpose each neighboring pair of ring segments 315, although the insulators have been omitted from FIG. 3 for the purposes of clarity. The ion trap 310 also includes endcaps 317. The ring segments 315 and/or endcaps 317 may be substantially similar to like-named components described above.

The apparatus 300 may also include an ionization source 305, a first lens 320, a second lens 330, a sample inlet 340, a buffer gas inlet 350, a pump system 360, and/or a detector 370.

Depending on the type of sample and the method of introducing the sample into the apparatus 300, the ionization source 305 may be operable for electron impact ionization, photoionization, thermal ionization, chemical ionization, desorption ionization, spray ionization, and/or other processes. In the example depicted in FIG. 3, pass-through electrodes 307 extend from the ionization source 305 to outside the apparatus 300. The lenses 320, 330 may be electrically conductive plates with central apertures, or other means for applying an rf and/or dc bias to the incoming and outgoing ion streams. For example, one or both of the lenses 320, 330 may be substantially similar in composition and/or manufacture to the endcaps 317 of the ion trap 310. Moreover, one of both of the lenses 320, 330 may include an array or series of lenses or lens elements, such as the lens 330 which is depicted in FIG. 3 as comprising three different lens elements 335.

The sample inlet 340, buffer gas inlet 350, and pump system 360 may be conventional or future-developed means for routing the appropriate gases to and from the ion trap 310 and/or other portion of the apparatus 300. Exemplary buffer gases include, without limitation, helium and/or mixtures thereof.

The detector 370 may be or include a single-point ion collector, such as a Faraday cup or electronic multiplier, in which ions arrive at the collector individually. The detector 370 may alternatively be or include a multipoint collector, such as an array or microchannel plate collector, in which all of the ions arrive at the collector simultaneously. However, additional or alternative means may be employed as detector 370 within the scope of the present disclosure.

Referring to FIG. 4, illustrated is a graph depicting the relationship between ion detection and mass for a coaxial ring ion trap according to one or more aspects of the present disclosure, as well as for several cylindrical ring ion traps of the prior art. For example, for ions having an amu (atomic mass unit) of about 100, a detection time ranging between 555 μs and 580 μs is experienced with conventional cylindrical ring ion traps, whereas a detection time ranging between about 535 μs and about 545 μs may be experienced with a coaxial ring ion trap according to one or more aspects of the present disclosure. Similarly, for ions having an amu (atomic mass unit) of about 110, a detection time ranging between 760 μs and 780 μs is experienced with conventional cylindrical ring ion traps, whereas a detection time of about 750 μs may be experienced with a coaxial ring ion trap according to one or more aspects of the present disclosure.

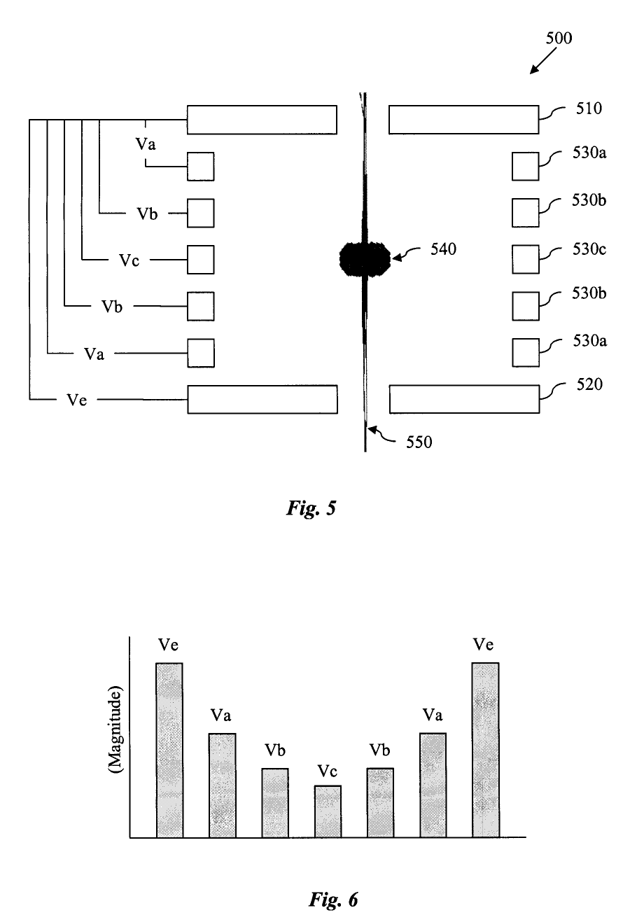

Referring to FIG. 5, illustrated is a schematic view of an apparatus 500 according to one or more aspects of the present disclosure. The apparatus 500 may represent another example of an implementation of the apparatus 100 and/or 200 described above. For example, the apparatus 500 may be or include a coaxial ring ion trap that may be substantially similar in composition and/or manufacture to the apparatus 100 shown in FIG. 1 and/or the apparatus 200 shown in FIG. 2D, or may otherwise have one or more aspects in common with the apparatus 100 of FIG. 1 and/or the apparatus 200 of FIG. 2D.

The apparatus 500 includes an injection endcap 510, an extraction endcap 520, and five coaxially aligned, cylindrical ring segments 530a-c. The endcaps 510, 520 are biased by signal Ve, the ring segments 530a are biased by signal Va, the ring segments 530b are biased by signal Vb, and the ring segment 530c is biased by signal Vc. Turning briefly to FIG. 6, illustrated is a chart graphically depicting an example of the relative magnitudes of each of these signals. In the illustrated example, Vb may be greater in magnitude than Vc, Va may be greater in magnitude than Vb, and Ve may be greater in magnitude than Va. Moreover, the collective bias profile generated by the signals Va, Vb, Vc, and Ve may be linear, exponential, parabolic, or hyperbolic, among other examples, such as in the example depicted in FIG. 6 in which Vb is about 30% greater in magnitude than Vc, Va is about 50% greater in magnitude than Vb, and Ve is about 70% greater in magnitude than Va.

Returning to FIG. 5, the signals Va, Vb, Vc, and Ve may each be (or include as a component) an rf or dc signal. For such rf signals or signal components, the frequency may range between about 100 kHz and about 2 GHz, although other frequencies are also within the scope of the present disclosure. Such frequencies may, for example, be a harmonic fraction of the resonant frequency of the apparatus 500.

The signals Va, Vb, Vc, and Ve may be configured such that ions are trapped in a central portion 540 of the apparatus 500 and extracted as an ordered ion stream 550, such as according to ion m/z ratio. However, other configurations are also within the scope of the present application.

Thus, it should be clear to those skilled in the art that the present application introduces an apparatus that is or includes an ion trap, wherein the ion trap comprises an injection endcap, an extraction endcap, a plurality of ring electrode segments collectively positioned in substantially coaxial alignment between the injection and extraction endcaps, and a plurality of insulators each interposing neighboring ones of the plurality of ring electrode segments.

The present application also introduces a method of manufacturing a coaxially segmented ring ion trap, comprising forming a first ring electrode segment over a substrate, forming a first insulator over the first ring electrode segment, and forming a second ring electrode segment over the first insulator. A second insulator is formed over the second ring electrode segment, and a third ring electrode segment is formed over the second insulator. A third insulator is formed over the third ring electrode segment, and a fourth ring electrode segment is formed over the third insulator.

The present application also introduces a mass spectrometer system having an ion trap, an ionization source, a sample gas inlet, and an ion detector. The ion trap includes an injection endcap, an extraction endcap, a plurality of ring electrode segments collectively positioned in substantially coaxial alignment between the injection and extraction endcaps, and a plurality of insulators each interposing neighboring ones of the plurality of ring electrode segments.

Positioning a plurality of coaxially aligned ring electrodes between the injection and extraction endcaps according to one or more aspects of the present disclosure may provide the ability to control the dc offset of each ring segment, which may improve ion packet focusing and defocusing within the ion trap. This may lead to the ability to control and improve ion packets for increased resolution, for example. The multi-ring segment configuration may additionally or alternatively provide the ability to control rf biasing on each ring segment, which may allow an increase in resolution, possibly causing a “resonant ejection” technique currently employed on cylindrical and quadrupole ion traps.

In one embodiment, one or more of the discrete ring segments is driven in accord with the following equation:

Vₒ=−(V_{dc}−V_{ac} cos(Ωt))

where Ω is a harmonic fraction of the resonant frequency of the ion trap, and may fall within the range of about 100 kHz and about 2 GHz.

Numerous operational methods may also be employed with one or more of the apparatus described above, including without limitation, double resonant ejection, variable pressure, variable buffer, etc. Moreover, ion traps within the scope of the present disclosure include those which do not have endcaps, such as one or both of the endcaps 130, 140 shown in the example depicted in FIG. 1. To continue with this example, embodiments in which one or more dedicated endcaps 130, 140 do not exist may utilize the outer one(s) of the ring segments 110 in a manner similar to the function of the dedicated endcaps.

It should also be noted that the number of coaxially aligned ring segments is not limited to the examples depicted in FIGS. 1, 2A-2D, 3, and 5. That is, embodiments within the scope of the present disclosure may include any number of coaxially aligned ring segments, possibly ranging between 2 to 300 or more. One such embodiment is an ion trap that includes 10 discrete, coaxially aligned ring segments.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An apparatus, comprising:
an ion trap, including:
an injection endcap having a first centrally located aperture;
an extraction endcap having a second centrally located aperture;
a plurality of ring electrode segments collectively positioned in substantially coaxial alignment between the injection and extraction endcaps; and
a plurality of insulators each interposing neighboring ones of the plurality of ring electrode segments.

2. The apparatus of claim 1 wherein the plurality of ring electrode segments is five ring electrode segments.

3. The apparatus of claim 1 wherein the plurality of ring electrode segments is ten ring electrode segments.

4. The apparatus of claim 1 further comprising a plurality of biasing means each configured to electrically bias a corresponding one of the plurality of ring electrode segments.

5. The apparatus of claim 1 wherein each of the plurality of ring electrode segments has an inner diameter ranging between about 100 μm and about 1 cm.

6. The apparatus of claim 1 wherein the plurality of ring electrode segments collectively define an internal volume of the ion trap, the internal volume having a substantially cylindrical shape having a length ranging between about 100 μm and about 1 cm.

7. A method of manufacturing a coaxially segmented ring ion trap, comprising:
forming a first ring electrode segment over a substrate;
forming a first insulator over the first ring electrode segment;
forming a second ring electrode segment over the first insulator;
forming a second insulator over the second ring electrode segment;
forming a third ring electrode segment over the second insulator;
forming a third insulator over the third ring electrode segment; and
forming a fourth ring electrode segment over the third insulator.

8. The method of claim 7 wherein:
forming the first ring electrode segment includes forming a first conductive layer including the first ring electrode segment and a first contact extending from the first ring electrode segment;
forming the second ring electrode segment includes forming a second conductive layer including the second ring electrode segment and a second contact extending from the second ring electrode segment;
forming the third ring electrode segment includes forming a third conductive layer including the third ring electrode segment and a third contact extending from the third ring electrode segment; and
forming the fourth ring electrode segment includes forming a fourth conductive layer including the fourth ring electrode segment and a fourth contact extending from the fourth ring electrode segment.

9. A mass spectrometer system, comprising:
an ion trap, including:
an injection endcap;
an extraction endcap;
a plurality of ring electrode segments collectively positioned in substantially coaxial alignment between the injection and extraction endcaps; and
a plurality of insulators each interposing neighboring ones of the plurality of ring electrode segments;
an ionization source;
a sample gas inlet; and
an ion detector.

10. The system of claim 9 wherein the plurality of ring electrode segments is five ring electrode segments.

11. The system of claim 9 wherein the plurality of ring electrode segments is ten ring electrode segments.

12. The system of claim 9 further comprising a plurality of biasing means each configured to electrically bias a corresponding one of the plurality of ring electrode segments.

13. The system of claim 9 wherein each of the plurality of ring electrode segments has an inner diameter ranging between about 100 μm and about 1 cm.

14. The system of claim 9 wherein the plurality of ring electrode segments collectively define an internal volume of the ion trap, the internal volume having a substantially cylindrical shape having a length ranging between about 100 μm and about 1 cm.
